(19) United States
(12) Patent Application Publication
(10) Pub. No.: US 2010/0115740 A1
(43) Pub. Date: May 13, 2010

(54) PASSENGER CONVEYOR HANDRAIL SPLICING TECHNIQUE

(76) Inventors: Changsheng Guo, South Windsor, CT (US); John M. Milton-Benoit, West Suffield, CT (US); John P. Wesson, Vernon, CT (US); Jun Ma, Manchester, CT (US)

Correspondence Address: CARLSON GASKEY & OLDS, 400 W MAPLE STE 350, BIRMINGHAM, MI, 48009, US

(21) Appl. No.: 11/995,936

(22) PCT Filed: Aug. 2, 2005
(86) PCT No.: PCT/US05/27399

§ 371 Date: Jan. 17, 2008

(51) Int. Cl. F16G 3/00; B23P 11/00

(52) U.S. Cl. 24/31 F; 29/428

(57) ABSTRACT

Making a passenger handrail (30) includes splicing together ends (58) of handrail stock. A disclosed device (50) includes mounting members (54), (56) for positioning the ends (58) of the handrail stock relative to each other before splicing them together. Example mounting members (54), (56) include position control members (80) having at least one tooth (82) for engaging a tooth (36) on a driven surface (34) of the handrail. A disclosed example includes a mover (62) having a threaded rod (66) that causes a follower (68) to move with the mounting member (54) for adjusting a position of the mounting member and the corresponding end (58) of the handrail stock within very stringent tolerance requirements.

### FIELD OF THE INVENTION

This invention generally relates to passenger conveyors. More particularly, this invention relates to making a handrail for a passenger conveyor.

### DESCRIPTION OF THE RELATED ART

Passenger conveyors have proven effective for carrying people between' different levels within a building or across an elongated pathway, for example. Typical arrangements include a handrail that rides over a balustrade and provides a surface for an individual to grab onto for increased confidence, better stability or both, for example. Typical handrail driving arrangements cause the handrail to move in unison with the steps or belt that carry passengers along the path of the conveyor. Typical handrail drive mechanisms rely upon pinching rollers that engage oppositely facing sides of the handrail to generate enough friction to drive the handrail in the desired direction.

There are several problems with conventional handrail driving arrangements. The pinching rollers engage the gripping surface side of the handrail, which tends to scratch and cause wear in the gripping surface. Another shortcoming is associated with the need for friction to cause appropriate movement of the handrail on the one hand and the need for a low friction cooperation between the handrail and the balustrade on the other hand.

There is a need for an alternative arrangement for driving handrails. One alternative is shown in U.S. Pat. No. 3,749,224, which includes a toothed belt for driving a handrail. While such arrangements can provide an enhancement to the driving of a handrail, they introduce other complexities.

For example, traditional handrails are manufactured by taking a length of handrail stock and splicing together two ends to form a belt or loop. Typical splicing techniques have relatively relaxed tolerances and do not require precise placement of the two ends relative to each other during the splicing operation. Most known arrangements include components to take up any slack in a handrail. With the use of a toothed driving wheel or belt and a correspondingly toothed handrail, further refinements must be made during manufacture. For example, it is necessary to establish an appropriate relationship between the teeth on the one end of the belt stock with the teeth on the other end of the belt stop to ensure a consistent tooth pitch even across the spliced portion. An interruption of the pitch along a splice may prevent appropriate cooperation with the drive mechanism eventually used to drive the handrail, for example.

This invention provides the ability to splice together ends of handrail stock to form a handrail that is capable of being driven by a profiled drive mechanism, for example.

### SUMMARY OF THE INVENTION

An example device for joining ends of a passenger conveyor handrail stock includes a plurality of mounting members that each have a configuration for cooperating with a portion of a driven surface on the handrail. At least one of the mounting members is moveable relative to the other. A mover selectively moves at least one of the mounting members relative to the other to establish a desired distance between the mounting members that corresponds to a desired spacing between the portions of the driven surface of the handrail before the ends are spliced together.

In one example, the mounting members each have at least one tooth that is adapted to cooperate with at least one tooth on the driven surface of the handrail.

In one example, the mover is manually controlled to achieve the desired distance. One disclosed example includes a threaded member such that the mover can be infinitely adjustable within a range of movement of the mover. A disclosed example allows for adjusting the relative positions of the portions of the driven surface of the handrail in increments of 0.01 mm.

The various features and advantages of this invention will become apparent to those skilled in the art from the following detailed description of a currently preferred embodiment. The drawings that accompany the detailed description can be briefly described as follows.

### BRIEF DESCRIPTION OF THE DRAWINGS

FIG. 1 schematically illustrated selected portions of a passenger conveyor system.

FIG. 2 is a perspective illustration of selected features of an example handrail.

FIG. 3 schematically illustrates a device for splicing together ends of handrail stock.

FIG. 4 schematically illustrates selected portions of the embodiment of FIG. 3.

### DETAILED DESCRIPTION

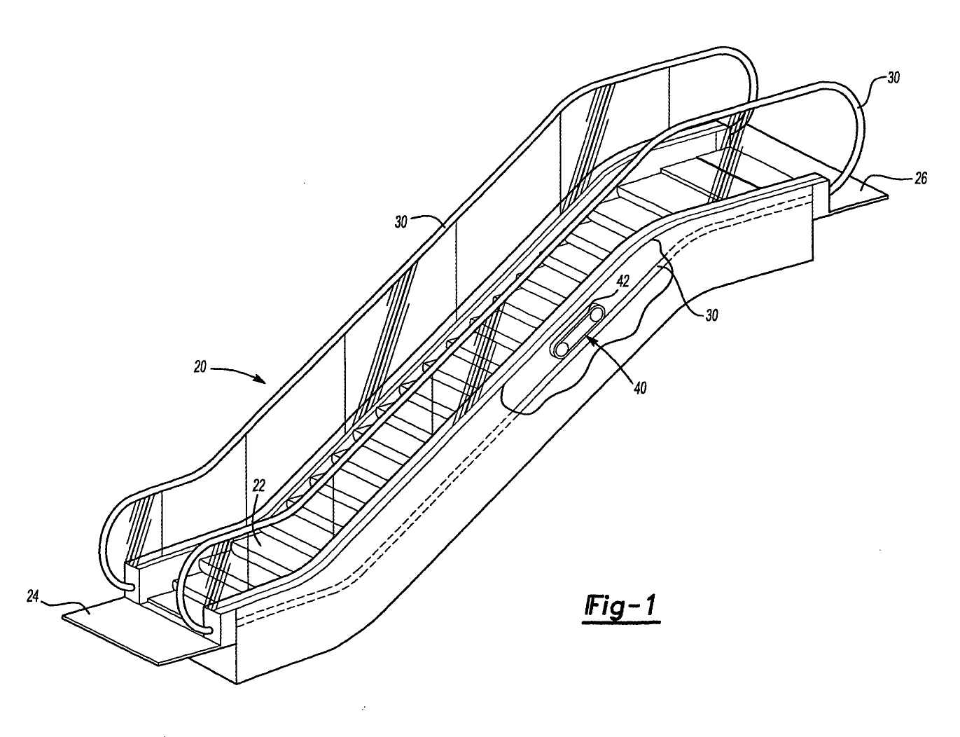

FIG. 1 shows a passenger conveyor 20. In this example, a plurality of steps 22 carry passengers between landings 24 and 26 at different levels within a building, for example. Although the illustrated conveyor 20 is an escalator, this invention is not limited to any particular style of passenger conveyor.

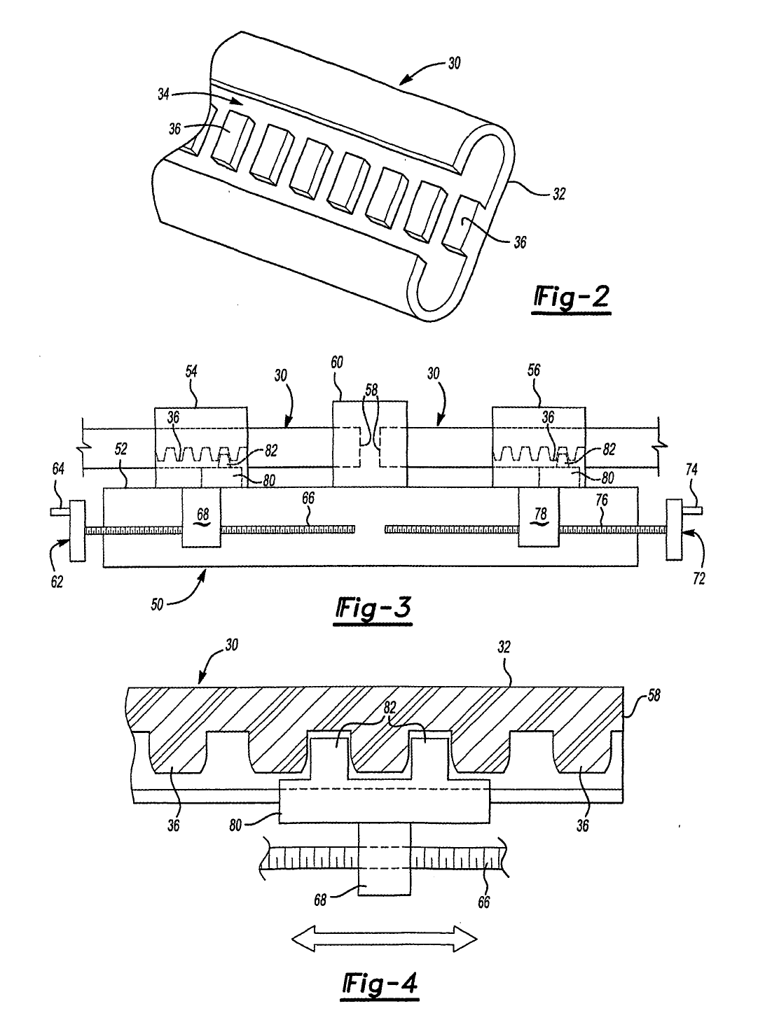

The passenger conveyor 20 includes a handrail 30 that can be grasped by an individual to increase their confidence, comfort or stability, for example, as they are carried by the conveyor 20. As can be appreciated best from FIG. 2, the handrail 30 includes a gripping surface 32 that faces generally upward along the path that passengers are carried by the conveyor 20. The handrail 30 also includes a driven surface 34 facing generally opposite from the gripping surface 32. In this example, the driven surface 34 includes a plurality of teeth 36. As can be appreciated from FIG. 1, a drive mechanism 40 includes a toothed belt 42 that cooperates with the teeth 36 on the handrail 30 for propelling the handrail 30 so that it moves in unison with the steps 22.

One example process of making the handrail 30 includes molding an elongated piece of handrail stock that has the teeth 36 formed on the driven surface 34. Two ends of the stock are then spliced together to form a continuous loop that is useful with the example conveyor 20 of FIG. 1. The presence of the teeth 36 requires special considerations for splicing together the ends of the handrail stock to ensure proper cooperation with the drive mechanism 40. For example, it is desirable to maintain a continuous and consistent pitch of the teeth 36 along the entire driven surface 34 to ensure proper cooperation with the drive mechanism 40. Undesirable changes in the spacing between the teeth 36 along an area where the ends of the handrail stock are spliced together interferes with proper operation of the handrail in some examples. If the pitch is not precisely controlled along the entire driven surface 34 in some cases, the drive mechanism will not properly mesh with the driven surface such that it cannot drive the handrail 30.

FIG. 3 schematically shows one example device 50 that is useful for splicing together ends of handrail stock and maintaining a desired relationship between the teeth 36 near each end. The example device 50 includes a base 52 that supports a plurality of mounting members 54 and 56. In this example, the mounting member 54 holds a portion of the handrail stock associated with one end 58 while the mounting member 56 holds another portion associated with an oppositely facing end 58. The mounting members 54 and 56 maintain the ends 58 relative to each other in a desired alignment and position within a mold 60 in this example.

At least one of the mounting members 54 or 56 is moveable relative to the base 52 for adjusting a spacing between the mounting members 54 and 56 and, therefore, a spacing between the ends 58 of the handrail stock. In the illustrated example, both of the mounting members are moveable relative to the base 52 and relative to each other.

One mover 62 is associated with the mounting member 54. The mover 62 includes a handle 64 that allows manual adjustment of the position of the mounting member 54 relative to the base 52. In this example, the mover 62 includes a threaded rod 66 and a correspondingly threaded follower 68. As the rod 66 is rotated, the follower 68 tends to move longitudinally along the rod (e.g., to the left or the right in the drawing). The follower 68 is appropriately associated with the mounting member 54 so that the mounting member 54 moves responsive to rotation of the threaded rod 66.

The illustrated example also includes a mover 72 having a handle 74, threaded rod 76 and follower 78 associated with the mounting member 56.

Using threaded rods in the movers 62 and 72 allows for an infinite amount of adjustment of the position of the mounting members relative to each other within a range of movement provided by the movers 62 ands 72. The example arrangement allows for adjusting the spacing between the ends 58 of the handrail stock to within a tolerance level of 0.05 mm. It is possible with such an arrangement, for example, to adjust the position of either end 58 relative to the other in increments of approximately 0.01 mm. Such an arrangement allows for precisely positioning the ends of the stock 58 relative to each other to achieve the desired end result of a handrail once the ends 58 are spliced together.

Because the example handrail 30 includes a toothed driven surface 34, it is necessary for an appropriate relationship between the teeth 36 associated with the ends 58 to be established to have a consistent pitch along the entire length of the handrail 30, for example. The example mounting members 54 and 56, as best appreciated from FIG. 4, include a positioning member 80 having at least one tooth 82 that cooperates with the teeth 36 on the handrail 30. The position of the teeth 82 relative to each other can be situated to provide a corresponding desired spacing between teeth 36 on or near the ends 58 of the handrail stock.

In one example, the mold 60 includes at least one mold half having a toothed configuration for establishing one or more teeth 36 along the spliced portion of the handrail. In another example, the mold 60 does not establish any teeth 36 along the spliced portion. Depending on the particular drive device 40, it may not be necessary to have one or more teeth 36 along the spliced portion established by the mold 60 provided that the overall relationship between the teeth 36 is accurate enough to ensure proper cooperation with the drive mechanism 40.

In the illustrated example, each positioning member 80 has a plurality of teeth 82 with a pitch corresponding to a pitch of the teeth 36.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A device for joining ends of a passenger conveyor handrail, comprising:
a plurality of mounting members that each have a configuration for cooperating with a portion of a driven surface on the handrail, at least one of the mounting members being moveable relative to the other; and
a mover for selectively moving at least the one of the mounting members relative to the other to establish a desired distance between the mounting members corresponding to a desired spacing between the portions of the driven surface.

2. The device of claim 1, wherein the mounting members comprise at least one tooth that is adapted to cooperate with at least one tooth on the driven surface of the handrail.

3. The device of claim 2, wherein each mounting member comprises a plurality of teeth having a pitch corresponding to a pitch of teeth on the handrail driven surface.

4. The device of claim 1, wherein the mover is manually controllable to achieve the desired distance.

5. The device of claim 1, wherein the mover comprises a threaded member and a follower that follows threads of the threaded member such at least the one mounting member moves responsive to rotation of the threaded member.

6. The device of claim 5, wherein the follower comprises a threaded member secured to at least the one mounting member.

7. The device of claim 1, wherein each of the mounting members is moveable relative to the other.

8. The device of claim 1, comprising a mold at least partially between the mounting members for forming a portion of the handrail between the ends.

9. The device of claim 1, wherein the mover is operative for moving at least the one of the mounting members to establish the desired distance within a tolerance range of approximately 0.05 mm.

10. The device of claim 1, wherein the mover is operative for moving at least the one of the mounting members in increments of approximately 0.01 mm.

11. The device of claim 1, wherein the desired distance is infinitely adjustable within a range of movement provided by the mover.

12. A method of joining ends of a passenger conveyor handrail, comprising the steps of:
engaging at least one tooth near one end of handrail stock;
engaging at least one tooth near another end of the handrail stock; and
selectively positioning the engaged teeth relative to each other to establish a desired distance between the teeth for joining the ends of the handrail stock.

13. The method of claim 12, comprising subsequently splicing together the ends.

14. The method of claim 12, comprising establishing the desired distance between the teeth to a tolerance within about 0.05 mm.

15. The method of claim 12, comprising moving at least one of the teeth relative to the other tooth in increments of approximately 0.01 mm.

16. The method of claim 12, comprising establishing a consistent pitch of teeth on a driven surface of the handrail along an entire length of the handrail.
